(19) United States
(12) Patent Application Publication
(10) Pub. No.: US 2008/0008732 A1
(43) Pub. Date: Jan. 10, 2008

(54) Chalkbrood Determent

(76) Inventors: Kiyoshi Kamei, Echizen (JP); Hidenao Saito, Echizen (JP); Junichi Matsubuchi, Tokyo (JP); Satoru Noda, Hidakagawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/667,839

(22) PCT Filed: Dec. 15, 2005
(86) PCT No.: PCT/JP05/23016

§ 371 Date: May 16, 2007

(30) Foreign Application Priority Data
Dec. 17, 2004 (JP) 2004-366097

(51) Int. Cl. A01N 25/08; A01N 47/46; A01P 3/00

(52) U.S. Cl. 424/409; 514/514

(57) ABSTRACT

The invention provides a means of deterring chalkbrood which is safer to honeybees and effective for a prolonged period. A chalkbrood determent comprising a carrier having a mixture of an isothiocyanate ester and an organic acid triglyceride and/or a rosin compound fixed to a carrier material with an embedding material is placed in a beehive or therearound.

### TECHNICAL FIELD

The present invention relates to a chalkbrood determent.

### BACKGROUND ART

In keeping honeybees, the infection of their colony with fungi causes not only a reduction in the amount or quality of honey produced, but also deteriorates the health of honeybees, which may sometimes kill off the colony. Among such diseases, chalkbrood is a disease caused by infection of honeybees with a fungus called Ascosphaera apis, which is highly infectious, so that there is a possibility that upon infection, the disease is transmitted not only to the colony infected therewith but also to other colonies, resulting sometimes in a tremendous loss in beekeeping.

The chalkbrood fungus is highly resistant to chemicals, so that countermeasures against this disease are limited. By way of example, a method of spraying sorbic acid, propionic acid, hinokitiol, pyrolignous acid, etc. is known, but use of some chemicals is troublesome because problems, such as residual chemicals and smelling are caused upon spraying at the time of collection of honey, for example. Even when such chemicals can be used, their effect is low and the effect is hardly long-lasting, and thus such treatment should be frequently carried out. As a countermeasure for increasing the duration of the effect, thereby reducing the frequency of such treatment, Patent Document 1 describes an antibacterial agent against Ascosphaera apis, a fungus that causes chalkbrood, which contains isothiocyanate as an antibacterial substance, as well as an organic acid monoglyceride, a polyglyceryl fatty acid ester, etc.

However, even if the method in Patent Document 1 is used, the period during which chalkbrood can be deterred is about 2 months, so that at a frequency adapted to this time cycle, isothiocyanate has to be added. If isothiocyanate in a gaseous state at high concentration or in a liquid state is brought into contact with honeybees, although it can deter the growth of Ascosphaera apis, it can be sometimes harmful to honeybees themselves. Thus, handling was difficult.

On the other hand, Patent Document 2 discloses a method of controlling the volatilized amount of an isothiocyanate as an antibacterial agent for articles such as livestock products, fishery products, agricultural products, cooked foods, processed foods, feed, leather products (such as shoes), books and works of art, which comprises mixing allyl isothiocyanate with fatty acid triglyceride. Patent Document 2, however, enumerates only lifeless objects as the subject to which the mixed allyl isothiocyanate is applied, and application thereof to living things is not envisioned.

Patent Document 3 describes a method of kneading allyl isothiocyanate with rosin to use it as a preservative having a fungicidal action, fungistatic action and antifungal action on fungi, such as bactericidal action and bacteriostatic action on aerobic bacteria and anaerobic bacteria and effective for products such as food having a problem of growth of harmful microorganisms and for prevention of putrefaction and fermentation of food, etc., a preservative for leather products, books and works of art, particularly antique art, and as a mothproofing agent for building materials, farm products, clothing, etc. However, in Patent Document 3 similar to Patent Document 2, application of the mixed allyl isothiocyanate to living things is not envisioned either.
Patent Document 1: JP patent publication 2002-193717A
Patent Document 2: WO95/12981
Patent Document 3: JP patent publication 10-53755A

### DISCLOSURE OF THE INVENTION

Problems to be Solved by the Invention

An object of the present invention is to provide a means of deterring chalkbrood which is safer to honeybees and effective for a prolonged period.

Means for Solving the Problems

According to the present invention, there is provided a chalkbrood determent comprising a carrier having a mixture of an isothiocyanate ester and an organic acid triglyceride and/or a rosin compound fixed to a carrier material by means of an embedding material. By placing this chalkbrood determent in a beehive or therearound, it is possible to deter chalkbrood for at least 3 months.

Effect of the Invention

By regulating the mixing ratio of an isothiocyanate ester to an organic acid triglyceride and a rosin compound, which have high affinity for the isothiocyanate, the vapor pressure thereof can be regulated, thereby stably controlling the volatilized amount of the isothiocyanate into the air. Because the mixture is fixed to the carrier material by the embedding material, the determent can be more easily handled than when used in a liquid state. With this arrangement, an excessive increase in the concentration of the isothiocyanate ester in a gaseous phase can be suppressed, and honeybees can be prevented from directly contacting liquid isothiocyanate ester, thereby restraining the bees from losing health.

The chalkbrood determent thus prepared is placed in a beehive or therearound, whereby the volatilized amount of the determent can be maintained for a prolonged period to such a degree as to deter the growth of Ascosphaera apis. The frequency of replenishment of a beehive with the determent can thereby be reduced to improve working efficiency.

Best Mode for Embodying the Invention

Hereinafter, the present invention is described in more detail.

The chalkbrood determent of the present invention comprises a carrier having a mixture of an isothiocyanate ester and an organic acid triglyceride and/or a rosin compound fixed to a carrier material by means of an embedding material.

The isothiocyanate ester can deter the growth of the fungus Ascosphaera apis, which causes chalkbrood, thereby restraining honeybees from contracting chalkbrood.

The isothiocyanate ester includes, for example, allyl isothiocyanate.

The organic acid triglyceride is one of esters consisting of 1 equivalent of glycerin and 3 equivalents of organic acid, i.e. a compound represented by the following chemical formula (1): 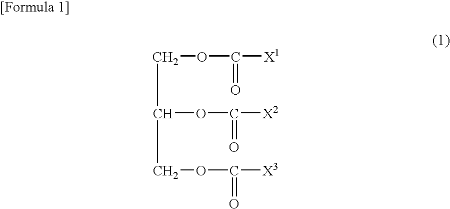
wherein X¹ to X³ each represent an organic base having an aliphatic chain or an aromatic ring and may optionally have a substituent base.

In particular, the organic acid triglyceride is preferably a fatty acid triglyceride represented by the following chemical formula (2). Each of p, q and r is preferably a natural number of 1 to 11 because with this arrangement, it is liquid at normal temperature and can thus be easily mixed with the isothiocyanate ester. 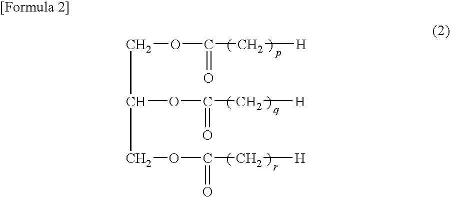
wherein p, q and r each represent a natural number.

The rosin compound includes not only rosin but also naturally occurring rosins containing one or more kinds of organic acids selected from abietic acid and abietic acid types such as neoabietic acid, dihydroabietic acid 14, tetrahydroabietic acid 14, and dehydroabietic acid 5 and pimaric acids such as d-pimaric acid 8, iso-d-pimaric acid 8 and levopimaric acid, products obtained by processing pine resin produced in different nations in the world, such as gum rosin, tall oil rosin, wood rosin, denatured rosins obtained by hydrogenation, disproportionation, polymerization, etc. of these rosins, and rosin esters such as ester gum obtained by esterification of the above rosins.

The vapor pressure of the isothiocyanate ester can be reduced by mixing it with the organic acid triglyceride and/or rosin compound, thereby suppressing the volatilization thereof.

The isothiocyanate ester, the organic acid triglyceride and/or the rosin compound should be mixed at such a mixing ratio that the isothiocyanate ester is gradually released over a prolonged period of time. If organic acid triglyceride is used, the mixing ratio by weight of the organic triglyceride to the isothiocyanate ester is preferably 10 to 500, more preferably 25 to 300. If the ratio is less than 10, the suppressing effect on the vapor pressure of the isothiocyanate ester is low, so that the isothiocyanate ester may be released too much. If the ratio is greater than 500, the vapor pressure is considerably reduced, so that the isothiocyanate ester may not be released in some cases. If rosin ester is used as the rosin compound, the mixing ratio by weight of the rosin ester to the isothiocyanate ester is preferably 10 to 500, more preferably 20 to 300. If the ratio is less than 10, the suppressing effect on the vapor pressure of the isothiocyanate is low, so that the isothiocyanate ester may be released too much. If the ratio is greater than 500, the vapor pressure is considerably reduced, so that the isothiocyanate ester may not be released in some cases. If both the organic acid triglyceride and the rosin compound are mixed with the isothiocyanate ester, the arbitrary mixing ratio by weight of the organic acid triglyceride and rosin compound to the isothiocyanate ester is preferably 10 to 500, more preferably 20 to 300.

The carrier material refers to a material which can carry a mixture of the isothiocyanate ester and the organic acid triglyceride and/or the rosin compound. Such carrier materials include cellulose and cellulose derivatives such as cellulose acetate, carboxymethyl cellulose, etc., hydrophilic polymers such as starch, alginate, polyvinyl alcohol, polyamide, polyacrylic acid, etc., and inorganic materials such as calcium silicate. The form of this carrier material is not particularly limited, and an arbitrary form can be selected. Examples include spherical, block-shaped or sheet-like porous beads, fabrics, non-woven fabrics, sheets, mats, etc.

In fixing the mixture to the carrier material, the isothiocyanate ester and the organic triglyceride and/or the rosin compound have to be carried together with the embedding material. The substance usable as such embedding material is preferably a substance which does not react with the isothiocyanate ester, is solid at normal temperature and becomes liquid by melting at a temperature at which the isothiocyanate ester does not decompose, boil or deteriorate. A substance which is liquid when mixed with the mixture and can later become solid at normal temperature by e.g. chemical reaction may also be used as the embedding material.

Substances usable as the embedding material may be embedding materials which are solid at normal temperature, such embedding materials including gels such as agar, carrageenan, curdlan, sodium alginate, etc., petroleum waxes such as mineral wax, paraffin wax, microcrystalline wax, etc., natural waxes such as carnauba wax, rice wax, etc., aliphatic alcohols such as stearyl alcohol, behenyl alcohol, tetradecanediol, hexadecanediol, etc., fatty acids such as palmitic acid, stearic acid, etc., fatty acid amides such as octadecanamide, esters of fatty acid such as sucrose stearate, sucrose palmitate, glycerol monostearate, glycerol monobehenate, etc., and high-molecular-weight polyoxyalkylene glycols such as polyethylene glycol, polypropylene glycol, etc. The Wax means both the abovementioned petroleum wax and natural wax. Embedding material which are liquid when mixed with the mixture and can become solid at normal temperature by e.g. chemical reaction include, for example, urethane resin, UV-curing resin, etc. Such an embedding materials may be used singly or a plurality of such embedding materials may be mixed together.

The mixing ratio by weight of the embedding material to the mixture is preferably 10 to 500, more preferably 20 to 300. If the ratio is less than 10, the embedding material and the mixture, when mixed with each other, may not be solidified by cooling or hardened by chemical reaction. If the ratio is greater than 500, the content of the mixture is low relative to the content of the carrier material and the volume of the entire agent tends to be too large, so that the arrangement of the agent in a beehive may be inconvenient in some cases.

The method of fixing the mixture to the carrier material by means of the embedding material is not particularly limited. For example, the carrier material may be soaked in a solution of the mixture, or the carrier material may be coated with a solution of the mixture.

The carrier having the mixture fixed to the carrier material may be placed in position as it is as a chalkbrood determent, or the carrier may be placed in a bag or container prior to use as a chalkbrood determent. This bag or container has to be gas-permeable but has to be capable of preventing bleeding of the isothiocyanate ester. For example, materials usable for such a bag include polypropylene (hereinafter abbreviated as “PP”) and polyethylene terephthalate (hereinafter abbreviated as “PET”). The thickness of the PP film is preferably 15 to 500 μm, more preferably 20 to 200 μm. Use of the PET film as the substrate is preferable because the PET film prevents excessive permeation of the isothiocyanate ester therethrough even if the ambient temperature during use is high and changes in a wide range. The thickness of the PET film is preferably 7 to 30 μm, more preferably 9 to 20 μm. Such a film may be formed into a bag by bonding the film with an adhesive or by welding weld layers provided on the film together. Methods of providing the weld layers include, for example, a method of laminating a polyethylene or cast polypropylene film on one side of the PET film.

By placing this chalkbrood determent directly in a beehive, it is possible to prevent honeybees from directly contacting the liquid-phase isothiocyanate ester prior to volatilization, thus restraining the bees from losing health, because the chalkbrood determent is covered with a bag or a container. The volatilized amount of the determent can be controlled more finely according to the type of the packaging bag or container.

By placing this chalkbrood determent or the chalkbrood determent agent in a beehive or therearound, the isothiocyanate ester can be gradually volatilized in the beehive, thereby deterring the growth of Ascosphaera apis, which causes chalkbrood, and deterring chalkbrood without harming honeybees themselves. When the chalkbrood determent is placed in a beehive, the determent may be attached to a lid or inner wall of the beehive, thrown into the beehive, or placed in a space specially arranged in the beehive, thereby directly dispersing the isothiocyanate ester in the beehive. Alternatively, the chalkbrood determent may be attached not to the inside of the beehive but to the outer wall or lower part of the beehive, thereby allowing the isothiocyanate to be indirectly volatilized into the beehive.

The concentration of the isothiocyanate ester in the air that is necessary to deter growth of the fungus causing chalkbrood and does not exert adverse influence on the health of honeybees, is preferably 0.05 to 10 ppm, more preferably 0.1 to 5 ppm. If the concentration is less than 0.05 ppm, the growth of the fungus cannot be deterred in some cases. If the concentration is greater than 10 ppm, honeybees may be hurt or may not remain in the beehive.

### EXAMPLES

Hereinbelow, the present invention is described in more detail by reference to the Examples.

### Example 1

14 parts by weight of wax (PW155, manufactured by Nippon Seiro Co., Ltd.) as an embedding material, 11 parts by weight of fatty acid triglyceride (Sun Crystal, manufactured by Nippon Seiyu Co., Ltd.) and 46 parts by weight of allyl isothiocyanate (manufactured by Nippon Terpene Co., Ltd.) were mixed together and liquefied under heating at 80° C. in a kneader, and then 29 parts by weight of porous cellulose particles (AH-2050L, manufactured by Rengo Co., Ltd.) were introduced into the mixture. Thereafter, the mixture was cooled under stirring to a temperature of 50° C. or less in the kneader, whereby a chalkbrood determent comprising the mixture of allyl isothiocyanate and fatty acid triglyceride fixed to the carrier material by means of the wax as the embedding material was obtained.

Then, 2 g of the resulting determent was placed in a bag of a laminated film consisting of 12 μm PET film and 30 μm polyethylene film and having an external size of 50 mm×50 mm with 3 sides heat-sealed, to give a chalkbrood determent agent.

A plurality of the thus obtained chalkbrood determent agents were placed in 6 places in a beehive with dimensions of about 50 cm×50 cm×40 cm (volume: about 100 L), and how chalkbrood was deterred was observed with time with the naked eye. To measure the amount of allyl isothiocyanate released from the agent, the weight of the chalkbrood determent agent was measured with time. Because the component released from the agent was allyl isothiocyanate only, the reduced amount of allyl isothiocyanate was regarded as the volatilized amount (mg/day). A detector tube was inserted into the beehive through its gap to measure the concentration of allyl isothiocyanate (ppm) in the beehive. The results of measurement are shown in Table 1. In the deterred state of chalkbrood in the table, o was given where chalkbrood did not occur, and x was given where chalkbrood occurred. The temperature at the time of measurement was 25° C. after 1 month, 32° C. after 3 months and 20° C. after 6 months.

TABLE 1

| | Number of days elapsed | | | | | | | | |
|---|---|---|---|---|---|---|---|---|---|
| | After 1 month | | | After 3 months | | | After 6 months | | |
| | | Volatilized | | | Volatilized | | | Volatilized | |
| Evaluation | | amount | | | amount | Concentration | | amount | Concentration |
| Items | Determent | (mg/day) | Concentration (ppm) | Determent | (mg/day) | (ppm) | Determent | (mg/day) | (ppm) |
| Example 1 | ∘ | 25 | 0.9 | ∘ | 31 | 1.0 | ∘ | 22 | 0.5 |
| Example 2 | ∘ | 54 | 1.6 | ∘ | 60 | 1.8 | x | 1 | 0.0 |
| Comparative | x | — | — | — | — | — | — | — | — |
| Example 1 | | | | | | | | | |
| Comparative | ∘ | 147 | 5.1 | x | 2 | 0.0 | — | — | — |
| Example 2 | | | | | | | | | |

### Example 2

2 g of the chalkbrood determent obtained in Example 1 was placed in a bag of a laminated film consisting of 40 μm biaxially oriented polypropylene (OPP) film and 30 μm polyethylene film and having an external size of 50 mm×50 mm with 3 sides heat-sealed, to give a chalkbrood determent agent. Then, in the same manner as in Example 1, how chalkbrood was deterred was observed, and the amount of allyl isothiocyanate released from the agent and the concentration of allyl isothiocyanate in the beehive were measured. The results are shown in Table 1.

### Comparative Example 1

When a beehive with the same size as used in Example 1, without placing the agent, was observed to determine how chalkbrood was deterred with time with the naked eye, generation of chalkbrood was confirmed after 1 month.

### Comparative Example 2

An agent was obtained in the same manner as in Example 1 except that the fatty acid triglyceride was not used. This agent was tested in the same procedure as in Example 1. The results are shown in Table 1.

### Results

In Comparative Example 1, in which the agent was not placed, chalkbrood was generated after 1 month, while in both Examples 1 and 2, wherein the agent was placed, generation of chalkbrood was not observed even after 3 months. Particularly, the amount of the isothiocyanate ester released per day was smaller in Example 1, which uses the PET film, than in Example 2, which uses the laminated film of OPP and polyethylene, thus enabling release for a longer period of time and maintaining the deterring effect of chalkbrood for 6 months. In Comparative Example 2, wherein the fatty acid triglyceride was not mixed in the agent, the amount of the isothiocyanate ester released was too large. Thus, although 1 month later, chalkbrood could be deterred, three months later, the volatilized amount became almost 0, resulting in generation of chalkbrood.

1. A chalkbrood determent comprising a carrier having a mixture of an isothiocyanate ester and an organic acid triglyceride and/or a rosin compound fixed to a carrier material by means of an embedding material.

2. The chalkbrood determent according to claim 1 wherein the isothiocyanate ester is allyl isothiocyanate.

3. The chalkbrood determent according to claim 1 wherein the embedding material is wax.

4. A chalkbrood determent agent comprising the chalkbrood determent of claim 1 placed in a gas-permeable bag or container.

5. A method of deterring chalkbrood, comprising placing, in a beehive or therearound, the chalkbrood determent of claim 1, to volatilize the isothiocyanate ester in the beehive, thereby deterring the growth of Ascosphaera apis as a fungus causing chalkbrood.

6. The chalkbrood determent according to claim 2 wherein the embedding material is wax.

7. A chalkbrood determent agent comprising the chalkbrood determent of claim 2 placed in a gas-permeable bag or container.

8. A chalkbrood determent agent comprising the chalkbrood determent of claim 3 placed in a gas-permeable bag or container.

9. A chalkbrood determent agent comprising the chalkbrood determent of claim 6 placed in a gas-permeable bag or container.

10. A method of deterring chalkbrood, comprising placing, in a beehive or therearound, the chalkbrood determent of claim 2, to volatilize the isothiocyanate ester in the beehive, thereby deterring the growth of Ascosphaera apis as a fungus causing chalkbrood.

11. A method of deterring chalkbrood, comprising placing, in a beehive or therearound, the chalkbrood determent of claim 3, to volatilize the isothiocyanate ester in the beehive, thereby deterring the growth of Ascosphaera apis as a fungus causing chalkbrood.

12. A method of deterring chalkbrood, comprising placing, in a beehive or therearound, the chalkbrood determent of claim 6, to volatilize the isothiocyanate ester in the beehive, thereby deterring the growth of Ascosphaera apis as a fungus causing chalkbrood.

13. A method of deterring chalkbrood, comprising placing, in a beehive or therearound, the chalkbrood determent agent of claim 4, to volatilize the isothiocyanate ester in the beehive, thereby deterring the growth of Ascosphaera apis as a fungus causing chalkbrood.

14. A method of deterring chalkbrood, comprising placing, in a beehive or therearound, the chalkbrood determent agent of claim 7, to volatilize the isothiocyanate ester in the beehive, thereby deterring the growth of Ascosphaera apis as a fungus causing chalkbrood.

15. A method of deterring chalkbrood, comprising placing, in a beehive or therearound, the chalkbrood determent agent of claim 8, to volatilize the isothiocyanate ester in the beehive, thereby deterring the growth of Ascosphaera apis as a fungus causing chalkbrood.

16. A method of deterring chalkbrood, comprising placing, in a beehive or therearound, the chalkbrood determent agent of claim 9, to volatilize the isothiocyanate ester in the beehive, thereby deterring the growth of Ascosphaera apis as a fungus causing chalkbrood.
